(19) United States
(12) Patent Application Publication
(10) Pub. No.: US 2015/0372447 A1
(43) Pub. Date: Dec. 24, 2015

(54) APPARATUS AND METHOD FOR GENERATING PULSE LASER

(71) Applicant: ELECTRONICS AND TELECOMMUNICATIONS RESEARCH INSTITUTE, Daejeon (KR)

(72) Inventors: Min Hyup SONG, Daejeon (KR); Bong Ki MHEEN, Daejeon (KR); Hong Seok SEO, Daejeon (KR); Yong Hwan KWON, Daejeon (KR); Ki Soo KIM, Seoul (KR); Dong Sun KIM, Yeongju-si (KR); Jung Ho SONG, Daejeon (KR); Jae Sik SIM, Daejeon (KR); Gyu Dong CHOI, Jeonju-si (KR)

(73) Assignee: ELECTRONICS AND TELECOMMUNICATIONS RESEARCH INSTITUTE, Daejeon (KR)

(21) Appl. No.: 14/732,392

(22) Filed: Jun. 5, 2015

(30) Foreign Application Priority Data
Jun. 19, 2014 (KR) 10-2014-0074966

(51) Int. Cl. H01S 3/11; H01S 3/067; H01S 3/10

(52) U.S. Cl. CPC H01S 3/11; H01S 3/10053; H01S 3/06754; H01S 3/10046

(57) ABSTRACT

Provided herein is a pulse laser generator including a modulator configured to receive a continuous wave laser, and to modulate an intensity and phase of the continuous wave laser to generate a first pulse laser; and a chirping unit configured to chirp the first pulse laser to generate a second pulse laser.

### CROSS-REFERENCE TO RELATED APPLICATION

The present application claims priority to Korean patent application number 10-2014-0074966, filed on Jun. 19, 2014, the entire disclosure of which is incorporated herein in its entirety by reference.

### BACKGROUND

1. Field of Invention

Various embodiments of the present disclosure relate to an apparatus and method for generating a pulse laser, and more particularly, to an apparatus and method for receiving a continuous wave laser and converting it to a pulse laser that has its basis on optical frequency combs (OFCs) generated by a harmonic wave generation method through phase modulation, and then chirping, amplifying and compressing the pulse laser to generate a pulse having an increased peak power.

2. Description of Related Art

A pulse laser is a laser having a high peak power for a short period of time. It is being used in a wide range of areas including precision spectroscopy, optical frequency measurement, precision distance/shape measurement, Arbitrary Waveform Generation (AWG), multi-channel optical communication, High Harmonic Generation (HHG), Microwave Photonics, and optical clocks. It is a light source particularly suitable for applications such as optical systems where spectroscopy and measurement is conducted using stabilized frequency combs (OFCs), and laser radar systems for measuring a distance to an object by emitting a pulse laser to the object and then measuring the light source that returns. Development on the pulse laser is oriented towards reducing the width of the pulse and increasing the peak power. Pulse lasers with high peak power are advantageous for long distance measurement and spectroscopy, and shape measurement, and for compensating the amount of light being lost while waiting or lost from a specimen measured, while the width of the pulse laser being short is related to widths of interference signals, allowing high resolution precision measurement and processing. Especially, a high peak power optical fiber ultrashort laser of which a long-term frequency stabilization is possible is a light source most suitable to application fields such as precision processing industries, applications for generation of frequency-stabilized optical frequency combs in the extreme ultraviolet band using the high-order harmonic wave generation phenomenon and spectroscopy and measurement, and laser radar systems for emitting a laser source to an object and then measuring a returning light source to calculate a distance to the object.

A pulse laser may be generated by a method for generating laser using a solid type laser represented by Titanium sapphire (Ti: sapphire), that is, a solid substance, or a method for generating laser using optical fiber. A laser generated using a solid substance has advantages of low phase noise characteristics while having a wide frequency spectrum, and wavelength conversion characteristics, but also disadvantages of insufficient scalability of its average power, a low efficiency due to difficulty of direct diode laser pumping, large volume, sensitivity to external environments, and difficulty in optical alignment and maintenance and repair due to the complexity of the system. A laser generated using optical fiber has a great advantage in thermal diffusion due to its large area per unit volume, and since a length of mutual reaction between a seed laser and a pump laser is not limited to a Rayleigh but corresponds to an entirety of length of the optical fiber, it is possible to obtain a high gain value with only one time single pass. Furthermore, a laser generated using optical fiber has a simple configuration, and easy to operate, and has excellent long-term stability. The frequency modes generated from an optical femtosecond laser usually oscillate independently, but it is possible to lock a phase of the modes by manual mode locking such as nonlinear polarization rotation, saturable absorber (SA), and nonlinear amplifying loop mirror (NALM) and so forth. Of these, the saturable absorber (SA) is a substance of which light absorption decreases when the intensity of light increases, and a mode lock using the saturable absorber (SA) generates a pulse more easily than other mode locks, and allows to configure a short resonator, thereby forming a femtosecond laser having a high repetition rate, and the polarization changes inside the optical fiber is less affected by changes of the surrounding environment. Some examples of these saturable absorbers that may be used in a mode lock are semiconductor saturable absorbers, carbon nanotubes, and graphene.

A pulse laser is generally connected to an amplifying stage to obtain high peak power, but when generating a pulse laser using optical fiber, amplification should be conducted with reduced peak power in order to prevent an optical system from being damaged by the high peak power. These days, a chirped pulse amplification system that uses the chirping technique of stretching a pulse along a time domain to reduce the pulse peak power is widely used. The peak power of a chirped laser is weaker than the peak power of the laser before it is chirped, and thus the maximum gain of amplification is increased while having the peak power below the level of damaging the optical fiber. A maximum amplification power in a chirped pulse amplification system is closely related to the level of chirping and compression applied by a pulse stretcher and compressor. In a conventional chirped pulse amplification system, a bulk type stretcher having a high level of chirping was used. Such a bulk type pulse stretcher stretches a pulse as it sends light outside and collects it back to optical fiber. Since light is sent outside from optical fiber and returned back to the optical fiber, there is much loss of signals, and when alignment is disaligned even slightly, there is much loss of light in the part where light is collected and is entered, which is a big disadvantage. Furthermore, there is also a problem that the system gets complicated, and stability of the surrounding environment decreases.

Some ideas for resolving these problems were proposed, but since they were all based on using a bulk type pulse stretcher, none could present a fundamental solution.

### SUMMARY

A first purpose of the present disclosure is to resolve the aforementioned problems, that is to provide an apparatus and method for receiving a continuous wave laser, converting it into a pulse laser, chirping the pulse laser along a time axis, and then performing amplification on the pulse laser in an in-line manner.

A second purpose of the present disclosure is to provide an apparatus and method for generating an optical fiber based pulse laser having high power characteristics while stabilizing frequency in a long term basis.

Furthermore, since the present disclosure has an in-line format, a third purpose is to provide an apparatus and method for generating a pulse laser which resolves the problem of loss, noise and signal distortion due to a bulk type stretcher.

Furthermore, a fourth purpose of the present disclosure is to provide an apparatus and method for generating a pulse laser which resolves the problem of generation of small pulses and self-starting due to the resonation method using a one-way method.

Furthermore, a fifth purpose of the present disclosure is to provide an apparatus and method for generating a pulse laser that is capable of quickly converting a repetition rate of the laser by quickly converting a frequency of an RF oscillator. A laser of which a line width and repetition rate may be quickly changed may be efficiently operated in long distance measurement systems and processing fields.

An embodiment of the present disclosure provides a pulse laser generator including a modulator configured to receive a continuous wave laser, and to modulate an intensity and phase of the continuous wave laser to generate a first pulse laser; and a chirping unit configured to chirp the first pulse laser to generate a second pulse laser.

Another embodiment of the present disclosure provides a pulse laser generation method, the method including receiving a continuous wave laser; generating a first pulse laser by modulating, by a modulator, a phase and intensity of the continuous wave laser; and generating a second pulse laser by chirping, by a chirping unit, the first pulse laser.

The present disclosure has an effect of providing a pulse laser generating apparatus and method that receives a continuous wave laser, converts it into a pulse laser, chirps the pulse laser along a time axis, and performs amplification in-line.

Furthermore, the present disclosure has an effect of providing a pulse laser generating apparatus and method that applies a strong phase adjustment (modulation) through a modulator and highly nonlinear optical fiber in the optical fiber without using a resonator, thereby forming wideband optical frequency combs. Since wideband optical frequency combs are formed in a single direction in the optical fiber, the problems of solid type lasers, that is, large volume, sensitivity to external environments, difficulty of optical alignment, and costly maintenance costs can be resolved.

Furthermore, since the laser is generated in a single direction method, the problems of using a resonator, that is, short pulse width, short optical frequency bandwidth, large phase noise, large offset frequency linewidth, and self-starting can be resolved. That is, the pulse laser generator of the present disclosure enables generation of a laser pulse having characteristics of high power, ultrashort, high stability, broadband, and high coherence.

Furthermore, the present disclosure has an in-line format, and by distributing a phase modulator and highly nonlinear optical fiber among amplification stages, it is possible to apply a strong chirping without having to use a bulk type stretcher, and it is possible to generate an in-line high power ultrashort laser, and thus has an effect of providing a pulse laser generating apparatus and method that resolves the problems of loss and signal distortion due to the bulk type stretcher. An in-line format pulse laser generator is capable of generating a high power ultrashort laser with less loss and distortion and reduced effects from environmental changes, which allows it to be applied to stable precision processing systems that is not affected by environments and mobile laser radar systems.

Furthermore, the present disclosure has an effect of providing a pulse laser generating apparatus and method capable of quickly converting a repetition rate of a laser by quickly converting a frequency of an RF oscillator. The conversion velocity of the repetition rate of the optical frequency combs is determined by the velocity of the frequency changes of the RF oscillator, and since as the frequency of the RF oscillator changes the repetition rate of the optical frequency combs changes in a single direction without interruption between modulators, the repetition rate may be changed quickly extremely stably.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a block diagram for explaining a modulator in a pulse laser generator according to an embodiment of the present disclosure;

FIG. 2 is a view for explaining changes in the laser that has gone through the modulator in the pulse laser generator according to the embodiment of the present disclosure;

FIG. 3 is a view for explaining a chirping unit, optical amplification unit and optical compression unit in the pulse laser generator according to the embodiment of the present disclosure;

FIG. 4 is a block diagram for explaining a modulator in a pulse laser generator according to another embodiment of the present disclosure;

FIGS. 5 to 7 are views for explaining the laser generated by the pulse laser generator according to the another embodiment of the present disclosure;

FIG. 8 is a flowchart for explaining a pulse laser generating method according to another embodiment of the present disclosure; and

FIG. 9 is a flowchart for explaining a step of generating a first pulse laser in the pulse laser generating method according to the another embodiment of the present disclosure.

### DETAILED DESCRIPTION

Hereinafter, embodiments will be described in greater detail with reference to the accompanying drawings. Embodiments are described herein with reference to cross-sectional illustrations that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present disclosure. Furthermore, ‘and/or’ may include any one of or a combination of the components mentioned.

Furthermore, a singular form may include a plural from as long as it is not specifically mentioned in a sentence. Furthermore, “include/comprise” or “including/comprising” used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

It is also noted that in this specification, “connected/coupled” refers to one component not only directly coupling another component but also indirectly coupling another component through an intermediate component. On the other hand, “directly connected/directly coupled” refers to one component directly coupling another component without an intermediate component.

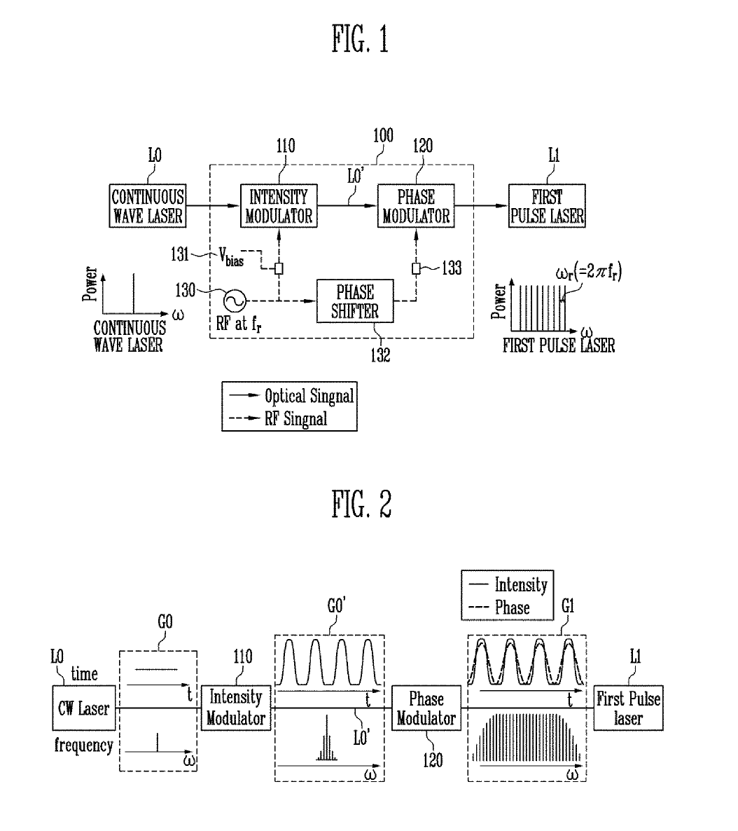

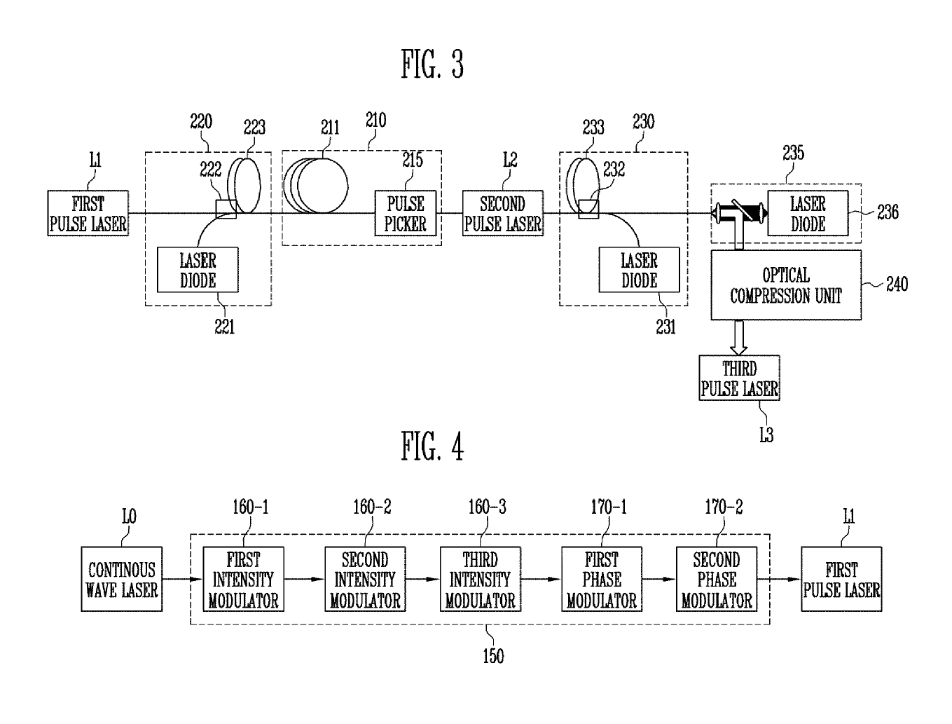

FIG. 1 is a block diagram for explaining a modulator in a pulse laser generator according to an embodiment of the present disclosure; and FIG. 2 is a view for explaining changes in the laser that has gone through the modulator in the pulse laser generator according to the embodiment of the present disclosure. Hereinbelow, explanation will be made with reference to FIGS. 1 and 2.

A modulator 100 receives a continuous wave laser (CW laser, L0), and generates a first pulse laser (L1) by modulating an intensity and phase of the continuous wave laser (L0). The modulator 100 includes an intensity modulator 110 and phase modulator 120.

The intensity modulator 110 modulates an intensity of the received laser based on an RF signal 130 received from an RF (RadioFrequency) signal generator (not illustrated) and a bias voltage 131, and outputs the modulated laser. The phase modulator 120 modulates a phase of the received laser based on a phase shift signal 133 generated by a phase shifter 132 that received the RF signal 130 and outputs the modulated laser. In FIG. 1, the intensity modulator 110 receives the continuous wave laser (L0) and outputs the laser (L0′) of which the intensity has been modulated, and the phase modulator 120 receives the laser (L0′) of which the intensity has been modulated and outputs a first pulse laser (L1), but the positions of the intensity modulator 110 and the phase modulator 120 may be switched.

Referring to the time domain (t) graph in the graph (G0) of the continuous wave laser (L0), the intensity of the laser is constant regardless of time. Referring to the frequency domain (ω) graph in the graph (G0), one can see that the laser is of a single frequency. Referring to a time domain (t) graph in the graph (G0′) of the laser (L0′) of which the intensity has been modulated, one can see the intensity of the laser changes according to time. Referring to a frequency domain (ω) graph in the graph (G0′), one can see that shapes of harmonic waves changed due to the modulation of intensity. Referring to the time domain (t) graph in the graph (G1) of the first pulse laser (L1), one can see that the intensity (solid line) and phase (dotted line) both change according to time. Referring to the frequency domain (ω) graph in the graph (G1), one can see that the spectrum of the frequency of the laser became wider. When a strong phase modulation is applied by a phase modulator that performs phase modulation in a sine wave format, time-to-frequency mapping will occur, and the shape of modulation in the time axis formed through the intensity modulator will be copied directly to be the shape of the spectrum after the phase modulator. That is, the modulator 110 modulates the intensity and phase of the continuous wave laser (L0) and generates optical frequency combs. That is, when the intensity and phase of the continuous wave laser (L0) that is of a single sine wave is modulated, a plurality of sine waves each having different frequencies are generated. The frequency and intensity of each sine wave may be adjusted by changing the number and detailed setting of the intensity modulator 110 and phase modulator 120. For example, when there is one intensity modulator and one phase modulator, twenty or more maximum points having a power difference of less than 10 decibel (dB) as compared to the maximum power will be generated, and when there are three intensity modulators and two phase modulators, optical frequency combs of a Gaussian format will be generated.

FIG. 3 is a view for explaining a chirping unit, optical amplification unit and optical compression unit of the pulse laser generator according to the embodiment of the present disclosure. The first pulse laser (L1) is amplified in a first optical amplification unit 220. Then, a second pulse laser (L2) is generated by a chirping of the chirping unit 210 and a choice by a pulse picker 215. The second pulse laser (L2) is amplified as it goes through a second optical amplification unit 230 and a third optical amplification unit 235. The optical compression unit 240 compresses the amplified second pulse laser (L2), and due to the compression, a third pulse laser (L3) is generated.

The chirping unit 210 includes optical fiber 211. When a laser having a high power goes through optical fiber having nonlinearity, the pulse is stretched along the time axis as it goes through a wave breaking phenomenon. Herein, the greater the nonlinearity, the greater the wave breaking phenomenon, thereby increasing the degree (degree of chirping) of the pulse being stretched along the time axis. Therefore, photonic crystal fiber (PCF) and highly nonlinear fiber (HNLF) having great nonlinearity may be used as the optical fiber 211. When the nonlinearity is great enough, there is no need to use a bulk type stretcher.

The chirping unit 210 further includes the pulse picker 215, and the pulse picker 215 picks (selects) the stretched first pulse laser and generates the second pulse laser. The pulse picker 215 changes an amplification rate by adjusting a repetition rate of the pulse. When generation and chirping of the pulse laser is possible in the optical fiber, it is possible to embody a system that receives a continuous wave laser (L0) in-line, and modulates the intensity and phase of the continuous wave laser (L0) to generate a first pulse laser (L1), and chirps and picks the first pulse laser (L1) to generate a second pulse laser (L2).

The first optical amplification unit 220 and second optical amplification unit 230 may amplify the laser in-line. Specifically, the optical amplification unit 220, 230 includes a laser diode 221, 231 that generates a laser for pumping; an optical coupler 222, 232 that couples a laser that needs to be amplified received from another optical fiber with the laser for pumping received from the laser diode 221, 231 and that transmits the coupled laser; and optical fiber for amplification 223, 233 that amplifies the coupled laser received from the optical coupler 222, 232. The optical fiber for amplification 223, 233 desirably consists of a substance that includes at least one of erbium (Er) and ytterbium (Yb). Since the degree of chirping in the chirping unit 210 is great, the peak power of the second pulse laser (L2) is low. In the case of the first optical amplification unit 220 and second optical amplification unit 230, the amplified peak power should be kept below a certain size for the optical fiber of the output end not to be destructed. Since the peak power of the second pulse laser (L2) is low, the amplification ratio (gain) of the second optical amplification unit 230 may increase.

The third optical amplification unit 235 includes a laser diode 236, and the third optical amplification unit 235 amplifies the laser. In the first optical amplification unit 220 and the second optical amplification unit 230, the amplified laser is output through the optical fiber, whereas in the third optical amplification unit 235, the amplified laser is output through air.

The optical compression unit 240 compresses the amplified second pulse laser (L2), and due to the compression, a third pulse laser (L3) is generated. A compression refers to gathering along the time axis as opposed to the chirping, and due to the compression, the peak power of the third pulse laser (L3) is stronger than the peak power of the second pulse laser (L2). The peak power of the third pulse laser (L3) is strong as much as to damage the optical fiber, and thus the optical compression unit 240 may include a bulk type optical compressor and not the optical fiber type optical compressor.

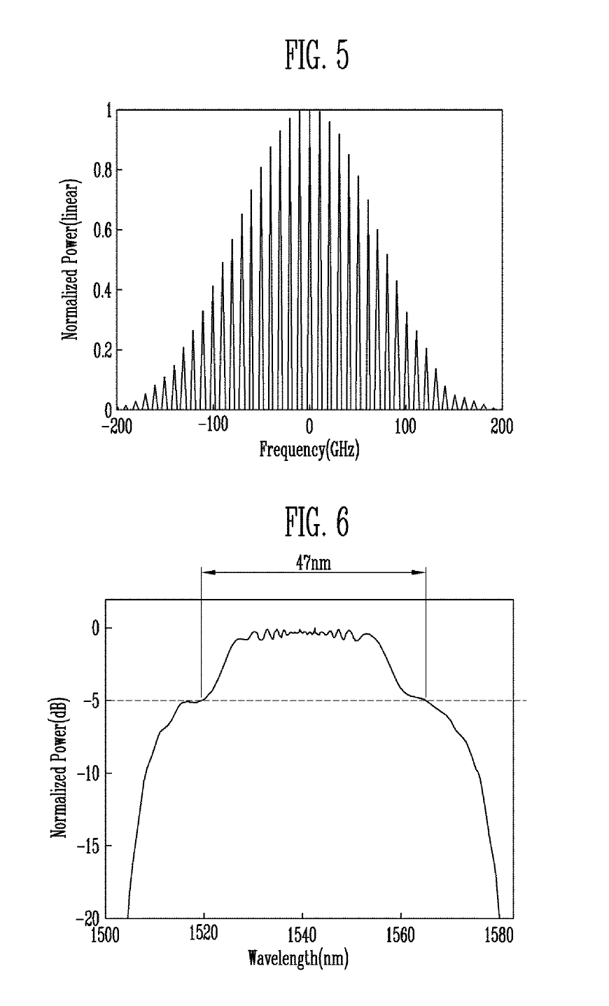

FIG. 4 is a block diagram for explaining a modulator in a pulse laser generator according to another embodiment of the present disclosure. Just like the modulator 100, the modulator 150 receives a continuous wave laser (L0), and modulates an intensity and phase of the continuous wave laser (L0) to generate a first pulse laser (L1). The modulator 150 includes intensity modulators 160-1 to 160-3, and phase modulators 170-1 to 170-2. Hereinbelow, explanation will be made with reference to FIGS. 1 to 4.

The first intensity modulator 160-1, second intensity modulator 160-2, and third intensity modulator 160-3 may perform the same functions as the intensity modulator 110; and the first phase modulator 170-1 and second phase modulator 170-2 may perform the same functions as the phase modulator 120. For the sake of convenience of explanation, an RF signal, bias voltage, and phase shifter are omitted. In FIG. 4, intensity modulation is performed three times, and phase modulation is performed twice, but this is a mere embodiment, and thus the number of times of performing the intensity modulation and phase modulation may be changed. The format of the first pulse laser (L1) in the frequency domain may be changed by the number of times of intensity modulation and phase modulation. For example, by changing the number of times of performing intensity modulation and phase modulation, the number of flat points (maximum points) of the generated optical frequency combs that exist in a frequency section where a difference of power or size from the peak power is or less than 10 dB may be adjusted. Furthermore, in the case of adjusting the number of times of intensity modulation and phase modulation well, for example, in the case of performing intensity modulation three times and performing phase modulation twice, the envelope of the frequency domain (ω) graph in the graph (G1) had a Gaussian format. That is, the modulator 150 generates a first pulse laser (L1) that corresponds to optical frequency combs of a Gaussian format (Gaussian OFCs).

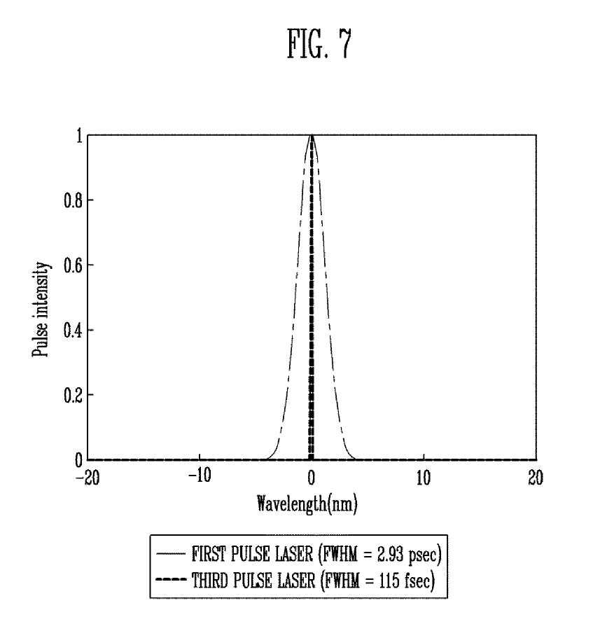

FIGS. 5 to 7 are views for explaining the laser generated by the pulse laser generator according to the another embodiment of the present disclosure. Hereinbelow, explanation will be made with additional reference to FIGS. 1 to 4.

FIG. 5 illustrates a simulation result of the first pulse laser (L1) generated by three intensity modulators 160-1 to 160-3 and two phase modulators 170-1, 170-2. Since the first pulse laser (L1) illustrated in FIG. 5 has gone through intensity modulation three times and phase modulation twice, the frequency domain (ω) graph in the graph (G1) had a Gaussian format. For the third pulse laser (L3) to be an ultrashort pulse of a clean and symmetrical shape, the second pulse laser (L2) has to be a supercontinuum source with an extremely short distance between optical combs in the frequency band, and for the second pulse laser (L2) to be the supercontinuum source, the first pulse laser (L1) has to have the Gaussian format.

FIG. 6 illustrates size of the second pulse laser (L2) per wavelength based on a simulation, the second pulse laser (L2) being the first pulse laser (L1) chirped by the chirping unit 210. The simulation was performed based on an assumption that the optical fiber 211 is a highly nonlinear medium (nonlinear constant: 1 0(/W•km), dispersion(discretion): −1.88 ps/nm/km) Referring to FIG. 6, one can see that the peak is flat. It is confirmed that the area of the wavelength of which the power is or above (maximum power: 5 dB) is very wide: 47 nm.

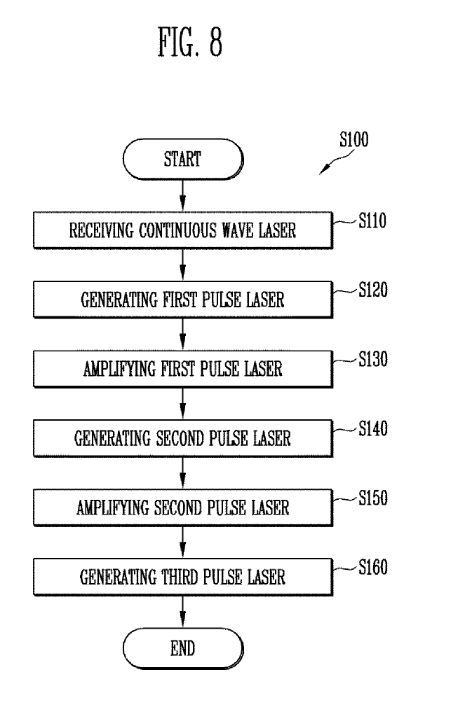

FIG. 7 illustrates size of pulse along the time axis regarding the first pulse laser (L1) of FIG. 5 and the second pulse laser (L2) of FIG. 6. A full width at half maximum of the first pulse laser (L1) is 2.93 picoseconds, and a full width at half maximum of the third pulse laser (L3) is 1153 femtoseconds.

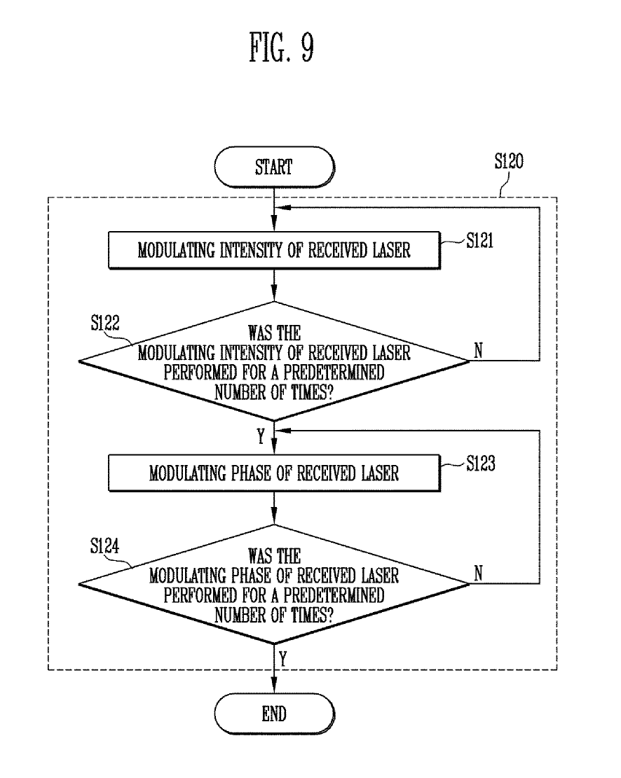

FIG. 8 illustrates a flowchart of a method for generating a pulse laser according to another embodiment of the present disclosure. The pulse laser generating method (S100) includes receiving a continuous wave laser (S110), generating a first pulse laser (S120), amplifying the first pulse laser (S130), generating a second pulse laser (S140), amplifying the second pulse laser (S150), and generating a third pulse laser (S160). Hereinbelow, explanation will be made with additional reference to FIGS. 1 to 4.

At the step of receiving a continuous wave laser (S110), the modulator 100 receives the continuous wave laser (L0).

At the step of generating a first pulse laser (S120), the modulator 100 generates the first pulse laser (L1) by modulating an intensity and phase of the laser (L0). Detailed explanation will be made with reference to FIG. 9 hereinbelow.

At the step of amplifying the first pulse laser (S130), the first optical amplification unit 220 amplifies the first pulse laser (L1). The detailed configuration of the first optical amplification unit 220 was already explained.

At the step of generating the second pulse laser (S140), the chirping unit 210 chirps the first pulse laser (L1) and generates the second pulse laser (L2). It was already explained hereinabove that when the chirping unit 210 includes photonic crystal fiber or highly nonlinear optical fiber with great nonlinearity, the first pulse laser (L1) is chirped sufficiently as it goes through the optical fiber.

At the step of amplifying the second pulse laser (S150), the second optical amplification unit 230 that may perform the same functions as the first optical amplification unit 220 amplifies the second pulse laser (L2). Furthermore, the third optical amplification unit 235 may amplify the amplified laser one more time through air.

At the step of generating a third pulse laser (S160), the optical compression unit 240 compresses the amplified second pulse laser (L2) and generates the third pulse laser (L3). It was already explained hereinabove that the peak power increases as the optical compression unit 240 compresses the second pulse laser (L2) and thus the pulse is gathered along the time axis.

FIG. 9 is a flowchart explaining the step of generating a first pulse laser in the pulse laser generating method according to the another embodiment of the present disclosure. The step of generating a first pulse laser (S120) includes a step of modulating an intensity of the received laser (S121), step (S122), a step of modulating a phase of the received laser (S123), and step (S124).

At the step of modulating an intensity of the received laser (S121), the intensity modulator modulates the intensity of the received laser. Changes in the time domain and frequency domain that occur due to the intensity modulation was already explained.

At step (S122), when intensity has been modulated for a desired number of times, the step of modulating a phase of the received laser (S123) is performed, but when intensity has not been modulated for a desired number of times, the step of modulating the intensity of the received laser (S121) is performed. The step (S122) may be set up by means of software, but it may also be set up by means of hardware by the number of intensity modulators connected serially to one another. For example, in the case of the embodiment illustrated in FIG. 4, there are three intensity modulators 160-1 to 160-3, and thus the step of modulating the intensity of the received laser is performed three times.

At the step of modulating the phase of the received laser (S123), the phase modulator modulates the phase of the received laser. Changes in the time domain and frequency domain that occur due to phase modulation was already explained hereinabove.

At the step (S124), if the phase has been modulated for a desired number of times, the step of generating the first pulse laser (S120) ends, but if the phase has not been modulated for the desired number of times, the step of modulating the phase of the received laser (S123) is performed. Just as the step (S122), the step (S124) may be set up by means of software or hardware.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A pulse laser generator comprising:
a modulator configured to receive a continuous wave laser, and to modulate an intensity and phase of the continuous wave laser to generate a first pulse laser; and
a chirping unit configured to chirp the first pulse laser to generate a second pulse laser.

2. The generator according to claim 1,
wherein the modulator comprises:
a first intensity modulator configured to modulate the intensity of the received laser based on an RF signal received from an RF signal generator and a bias voltage, and to output the modulated laser; and
a first phase modulator configured to modulate the phase of the received laser based on a phase shift signal generated by a phase shifter that received the RF signal and to output the modulated laser.

3. The generator according to claim 2,
wherein the modulator further comprises a second intensity modulator configured to perform a same function as the first intensity modulator.

4. The generator according to claim 2,
wherein the modulator further comprises a second phase modulator configured to perform a same function as the first phase modulator.

5. The generator according to claim 2,
wherein the first intensity modulator and first phase modulator receive or output the laser through optical fiber.

6. The generator according to claim 1,
wherein the chirping unit comprises optical fiber, and the optical fiber comprises at least one of highly nonlinear fiber and photonic crystal fiber.

7. The generator according to claim 1,
further comprising a first optical amplification unit configured to amplify the first pulse laser and to transmit the amplified first pulse laser to the chirping unit.

8. The generator according to claim 7,
wherein the first optical amplification unit comprises:
a laser diode configured to generate laser for pumping;
an optical coupler configured to couple a laser received from another optical fiber that needs to be amplified with the laser for pumping, and to transmit the coupled laser; and
optical fiber for amplification made of at least one of Er and Yb, and configured to amplify the coupled laser.

9. The generator according to claim 1,
further comprising an optical compression unit configured to compress the second pulse laser to generate a third pulse laser.

10. The generator according to claim 9,
further comprising a second optical amplification unit configured to amplify the second pulse laser received from the chirping unit and to transmit the amplified second pulse laser to the optical compression unit.

11. The generator according to claim 10,
wherein the second optical amplification unit comprises:
a laser diode configured to generate laser for pumping;
an optical coupler configured to couple a laser received from another optical fiber that needs to be amplified with the laser for pumping, and to transmit the coupled laser; and
optical fiber for amplification made of at least one of Er and Yb, and configured to amplify the coupled laser.

12. A pulse laser generation method, the method comprising:
receiving a continuous wave laser;
generating a first pulse laser by modulating, by a modulator, a phase and intensity of the continuous wave laser; and
generating a second pulse laser by chirping, by a chirping unit, the first pulse laser.

13. The method according to claim 12,
wherein the generating a first pulse laser comprises:
modulating an intensity of the received laser; and
modulating a phase of the received laser.

14. The method according to claim 13,
wherein at least one of the modulating an intensity of the received laser and the modulating a phase of the received laser is performed for a plurality of times.

15. The method according to claim 12,
wherein at the generating a second pulse laser, the first pulse laser is chirped by nonlinear optical fiber that comprises at least one of highly nonlinear fiber and photonic crystal fiber.

16. The method according to claim 12,
further comprising amplifying the first pulse laser after the generating a first pulse laser.

17. The method according to claim 12,
further comprising generating a third pulse laser by compressing the second pulse laser after the generating a second pulse laser.

18. The method according to claim 17,
further comprising amplifying the second pulse laser between the generating a second pulse laser and the generating a third pulse laser.
